(19) United States
(12) Patent Application Publication
(10) Pub. No.: US 2012/0036277 A1
(43) Pub. Date: Feb. 9, 2012

(54) Modified Stream Synchronization

(75) Inventors: Hans Maarten Stokking, Wassenaar (NL); Fabian Arthur Walraven, Groningen (NL); Mattijs Oskar van Deventer, Leidschendam (NL); Omar Aziz Niamut, Vlaardingen (NL)

(73) Assignees: Nederlandse Organisatie voor Toegepast-Natuurwetenschappelijk Onderzoek TNO, Delft (NL); KoninklijkeE KPN N.V., The Hague (NL)

(21) Appl. No.: 13/256,443

(22) PCT Filed: Mar. 16, 2010
(86) PCT No.: PCT/EP2010/053407

§ 371 Date: Oct. 10, 2011

(30) Foreign Application Priority Data
Mar. 16, 2009 (EP) 09003751.6
Dec. 9, 2009 (EP) 09015266.1

(51) Int. Cl. G06F 15/16

(52) U.S. Cl. 709/231

(57) ABSTRACT

A method and system for inter-destination synchronization of at least a first and a second stream is described, wherein the second stream is the output stream of a media stream modification unit using the first stream as an input stream. The method comprises the steps of: providing first arrival time information of a packet in the first stream arriving at a first synchronization point and second arrival time information of a packet in the second stream arriving at a second synchronization point; providing synchronization correlation information on the synchronicity relationship between said input stream and said output stream; and, calculating delay information on the basis of the first and second arrival time information and the synchronization correlation information.

### FIELD OF THE INVENTION

The invention relates to a method and a system for inter-destination synchronization of related streams. The invention further relates to a synchronization unit, a synchronization point, an arrival time information adjustment module and a data structure for use in such system and to a computer program product using such method.

### BACKGROUND OF THE INVENTION

New multi-media techniques such as Voice over IP (VoIP) and Internet Protocol Television (IPTV) open a whole range of new multi-media services. One type of these services enable a group of users to separately watch the same TV channel and communicate with each other using text, audio and/or video. Another type of these services provide interactive television experiences, such as a broadcasted television quiz wherein viewers at home may input answers to broadcasted questions and participate in the show. Such services require that the output signal of the terminals is transmitted at the same time to all users in the group. In other words, the outputs of the display or play-out devices in the group e.g. televisions, PDAs, mobile devices, PCs or a combination thereof, corresponding to different destinations, should be synchronized.

In an IPTV system, the TV channel signal is typically transmitted as one or more packetized streams over a high-bandwidth IP network of an operator via network nodes such as head-ends, edge routers and access nodes to the terminals of the subscribers to such services. During transmission of the streams, the packets are subjected to unknown delays in the network such as transmission delays, differences in network routes and differences in coding and decoding delays. As a consequence the temporal relationship between packets of audio and video streams received at a first terminal (a first destination) and those received at another second terminal (a second destination) will be disturbed.

To stream the IPTV content to the terminals usually the Real-Time Transport Protocol (RTP) is used. RTP provides sequence numbering and time stamping. Using RTP the temporal relation in one stream (intra-stream synchronization), between associated streams terminating at the same end-terminal (inter-stream synchronization) or between associated streams terminating at different end-terminals (group-synchronization or inter-destination synchronization) may be restored. The article “Multimedia group and inter-stream synchronization techniques: A comparative study” by F. Boronat et al. (Elsevier Information Systems 34 (2009) pp. 108-131) provides a comprehensive overview of known inter-destination synchronization techniques, which may be sub-divided in three main categories.

In the “Synchronization Maestro Scheme” (SMS), a central synchronization master collects timing information from all terminals in the group and adjusts the output timing by distributing control packets to the terminals. In the “Master-Slave Receiver Scheme” (MSRS), receivers (terminals) are classified into a master receiver and slave receivers. The master receiver multi-casts its output timing to the slave receivers, which adjust their output timing of packets accordingly. In the “Distributed Control Scheme” (DCS), each terminal (receiver) multicasts all timing information to all other terminals in the group and terminal is configured for calculating the appropriate output timing. These schemes have in common that the synchronization takes place either at the source or receiving end of a media stream.

The co-pending European patent application ______ describes a further inter-destination synchronization scheme wherein network nodes are synchronized somewhere along the paths of the streams between the source and receivers. This method is particularly suitable for large scale deployment and services that tolerate small differences in propagation times of streams resulting from differences in the access lines that connect the stream destinations to an operator network.

Most of the referenced inter-destination synchronization techniques make use of timing information (e.g. an RTP Time Stamp, the RTP Sequence Number of the received RTP media stream at a specific instance in time, or one or more equivalent parameters in a Transport Stream) on media stream reception at the terminals. By comparing timing information of different receivers, appropriate stream adjustments may be calculated. An exemplary adjustment may be a delay of the play-out time of the received stream by using a buffer at the receiver-end.

One problem related to these known synchronization schemes is that these schemes are not designed to deal with situations wherein the stream between the source and the receiver is modified for content preparation and/or content re-generation purposes.

Modification of a stream may be necessary and/or advantageous in a large number of situations. For example, to prepare a media stream for efficient delivery, media streams may be adjusted for specific requirements of the stream receivers or access lines such as a change in resolution (for example when n converting from HD to SD or converting to lower bit rate). In such situation a stream modification unit called a translator or transcoder may be placed in the path of the stream. The modified transcoder output stream may comprise different time stamps, sequence numbers or other timing information when compared with the original (unmodified) input stream.

Media streams may also be customized for specific customer requirements. Adding voice-overs, subtitles, Picture in Picture, to the main content stream may be needed. This is typically done by a stream modification unit called a mixer. Further, a stream may need to be re-generated when crossing network domains using a re-generator unit. All these content preparation and regeneration schemes may change the timing information in the stream thereby rendering known inter-destination synchronization schemes unreliable or even impossible to use. Hence, there is a need in the prior art for methods and systems which enable inter-destination synchronization between modified and unmodified streams or between two differently modified streams.

### SUMMARY OF THE INVENTION

It is an object of the invention to reduce or eliminate at least one of the drawbacks of synchronization schemes known in the prior art and to provide a method for inter-destination synchronization of at least a first and a second stream wherein said second stream may be the output stream of a media stream modification unit using the first stream as an input stream. The method may comprise the steps of: providing first arrival time information of a packet in the first stream arriving at a first synchronization point and second arrival time information of a packet in the second stream arriving at a second synchronization point; providing synchronization correlation information on the synchronicity relationship between said input stream and said output stream; and, calculating delay information on the basis of the first and second arrival time information and the synchronization correlation information. In a further embodiment, the method may further comprise the step of providing at least the first or the second synchronization point with said delay information, enabling the at least first or second synchronization point to delay the output of a stream such that the first and second streams outputted by the first and second synchronization point respectively are substantially synchronized.

By providing synchronization correlation information, related streams directed to a heterogeneous set of viewers, using different terminals, and or with different service requirements, may still be synchronized. The invention thus allows groups of viewers in a heterogeneous network to watch a media stream in a synchronized way.

Arrival time in this context is normally the time a synchronization point receives a particular part of a media stream. In the context of this invention, it is understood by anyone skilled in the art, that it is not necessary to use the exact packet arrival time here. The actual time used as arrival time information can vary slightly, depending on the precise point a synchronization point uses for determining arrival time. This may e.g. be directly upon arriving, before placing a packet in a jitter buffer. But it may also be in a point later in the process of handling the media packets, e.g. right before the decoding process or right before a translation process. A synchronization point may even be aware of the time necessary for processing a media packet up until the actual presentation of that particular part of the media content, and use the actual presentation time as arrival time information.

In one embodiment said first and second stream are outputted by at least first and second synchronization points and wherein said synchronization points being connected to at least one synchronization unit for synchronizing said synchronization points.

In another embodiment the step of calculation delay information may comprise an adjustment step for adjusting the first and/or second arrival time information to achieve a common timeline between first arrival time information and second arrival time information. The adjustment step may be based on at least part of the synchronization correlation information.

In one embodiment the adjustment step is executed by an arrival time information adjustment module, said module being part of a synchronization unit, the synchronization unit being provided with synchronization correlation information.

In another embodiment the adjustment step may be executed at the synchronization point, wherein the synchronization point may comprise an arrival time information adjustment module. Such arrival time information adjustment module may be provided with at least part of the synchronization correlation information, the synchronization unit being provided with adjusted second arrival time information.

In yet another embodiment, the adjustment step may be executed in a network element, wherein the network element may be arranged to receive arrival time information. The network element may further comprise an arrival time information adjustment module, the arrival time information adjustment module being provided with at least part of the synchronization correlation information and the synchronization unit being provided with adjusted second arrival time information.

In one embodiment the synchronization point may be a terminal or a network node, preferably an access node. In further variants the stream modification unit may be a translator or a mixer and the synchronization unit may be comprised in a synchronization point or a server

In a further aspect, the invention may relate to a synchronization unit, preferably a synchronization server, for synchronizing the output of at least a first synchronization point receiving a first media stream and a second synchronization point receiving a second media stream, wherein said second stream may be the output stream of a media stream modification unit using the first stream as an input stream. The synchronization unit may comprise: means for receiving first arrival time information of a packet in a stream arriving at the first synchronization point and second arrival time information of a packet in the second stream arriving at a second synchronization point; means for providing synchronization correlation information on the synchronicity relationship between said input stream and said output stream; and, means for calculating delay information on the basis of the first and second arrival time information and the synchronization correlation information.

In another embodiment, the synchronization unit may comprise: means for providing the first and the second synchronization point with the delay information enabling one or more variable delay units in the first and second synchronization points to delay the output time of the received streams such that they are substantially synchronized.

In a further aspect, the invention may relate to a system for inter-destination synchronization of the output of at least a first and a second synchronization point, wherein the system may comprise: a content delivery server for delivering a media stream; a stream modification unit configured to modify an input media stream into a modified output media stream and configured for providing synchronization correlation information on the synchronicity relationship between said input stream and said output stream; and at least one synchronization unit as described above.

In further aspects the invention may also relate to a synchronization point and a media stream modification unit for use in a system as described above. In yet another aspect the invention may relate to a data structure, preferably an RTCP extended report data structure, for use in a system as described above, wherein said data structure is used by said system for signaling synchronization status information associated with a packet in a stream arriving at a media synchronization point or a packet in a stream arriving at a media stream modification unit or a packet in a stream transmitted by said modification unit, and wherein said data structure comprises at least an identifier identifying the sender of said data structure, at least one timestamp, preferably an RTP and/or an NTP timestamp, and/or a media stream correlation identifier, said data structure allowing said synchronization unit to synchronize media streams associated with media synchronization points in said system.

The invention may also relate to a computer program product comprising software code portions configured for, when run in the memory of a computer, executing the method steps as described in the methods steps described above.

The invention will be further illustrated with reference to the attached drawings, which schematically show embodiments according to the invention. It will be understood that the invention is not in any way restricted to these specific embodiments.

### BRIEF DESCRIPTION OF THE DRAWINGS

FIG. 1 depicts an exemplary embodiment of a heterogeneous network topology, comprising multiple stream modification units, and capable of delivering related streams to different locations.

FIG. 2 depicts a system according to one embodiment of the invention.

FIG. 3 depicts a flow diagram associated with a system according to the invention.

FIG. 4 depicts a system according to another embodiment of the invention.

FIG. 5 depicts an implementation of the inter-destination synchronization scheme according to one embodiment of the invention.

FIG. 6 depicts an exemplary RTCP eXtended Report according to one embodiment of the invention.

FIG. 7 depicts the use of RTCP messages for synchronizing media stream according another embodiment of the invention.

### DETAILED DESCRIPTION

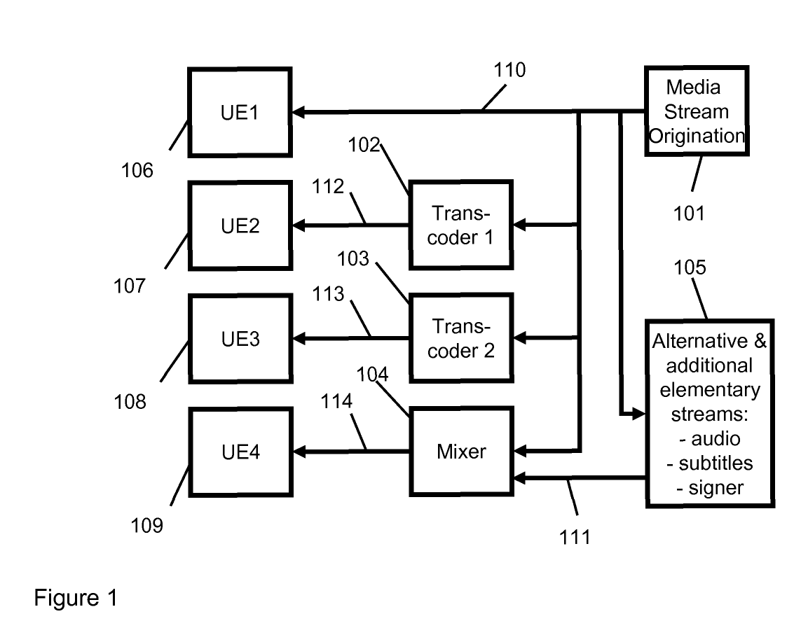

FIG. 1 depicts an exemplary embodiment of a multimedia delivery system 100 for delivering content to user equipments over a network. The network has a heterogeneous topology, comprising multiple stream modification modules and is capable of delivering related streams to different locations. In this embodiment a media stream comprising packets is delivered to multiple user equipments wherein the media stream is adapted differently for different user equipments.

A packet in the context of this application is a piece (i.e. a unit) of a media stream which is associated with timing information, e.g. time stamps. One example of such packets is an RTP packet comprising one or more timestamps. Another example is an MPEG-type packet, such as a Transport Stream (TS) packet comprising one or more presentation time stamps.

A skilled person will understand that any media packet format comprising timing information may be used for synchronization purposes. The timing information may be part of the transport container (the transport protocol), which is used for transporting the content, either standardized or proprietary. Alternatively or in addition it may also be part of the actual content, e.g. timing information used in the encoding scheme for encoding the content.

The multimedia delivery system in FIG. 1 comprises a media stream origination 101, e.g. a server capable of delivering media streams via one or more networks, e.g. an IP network, to different user equipments (UE) 106-109. A UE or a terminal may relate a play-out device or a device connected to one (e.g. a set-top box). Such devices may for instance include a mobile phone, television set, IP-phone, game console, smart metering device, etc., but it may also be any other automated action in response to a synchronized stream, such as the automated metering of a multiple metering devices in response to a synchronized signal.

The multimedia delivery system may comprise various network elements, which perform certain actions on a media stream so that the timing information in the stream is modified. Such a network element hereafter is generally referred to a stream modification unit. In the embodiment of FIG. 1, the system comprises various stream modification units, e.g. a first transcoder 102, a second transcoder 103, and a mixer 104. A server 105 may deliver alternative and/or additional elementary streams 105 to the mixer. This server 105 may for example deliver alternative audio (different languages, director's comments or surround sound), alternative subtitles, or alternative video (e.g. a signer that translates spoken language to sign language).

The original media stream 110 delivered by the media server 101 may be a video on demand (VoD) stream with MPEG4 encoding transported over the network using RTP over UDP over IP. This original media stream 110 is modified (i.e. transcoded) by the first transcoder 102 transcoding the original MPEG4 encoded stream into an MPEG2 encoded stream for the benefit of UE2 107, which only supports MPEG2 encoding. The transcoded media stream 112 is further transported to UE2 using RTP over UDP over IP.

The second transcoder 103 may transcode the original media stream 110 to a modified media stream having a container format different from the container format used by the original media stream whereby the actual encoding scheme is not changed. Second transcoder 103 may for example deliver the media stream encoded in MPEG4 over the network to UE3 108 using an MPEG Transport Stream carried directly over UDP. Further, mixer 104 may add one or more additional elementary streams to the original media stream or may replace one or more elementary media streams in the original media stream with one or more alternative elementary streams. These additional or alternative elementary streams are delivered by server 105 using RTP over UDP over IP. The mixer 104 subsequently delivers the mixed media stream 114 to UE4 using MPEG4 over RTP over UDP over IP.

In the multimedia delivery system as depicted in FIG. 1, the original media stream 110 may use a transport protocol comprising timing information. In one embodiment, the RTP protocol may be used as a transport mechanism. RTP uses RTP timestamps which may be used as timing information for synchronizing media streams.

The first transcoder 102 may decode the original stream 110, and re-encode the media (e.g. from MPEG4 to MPEG2). Hence, it will send out a modified media stream using a random RTP timestamp to indicate the start of its transmission to UE2 107. The timestamp of the outgoing media stream thus differs from the incoming media stream even though the same transport protocols are used (RTP over UDP over IP).

The second transcoder 103 does not decode the original stream 110, but sends the media stream 113 to UE3 108 using a different transport container. For example, an MPEG Transport Stream (TS) over UDP is used to send the content to UE3. These MPEG TS packets may contain timing information in the form of so-called Presentation Time Stamps (PTS) for indicating the instance at which a packet should be presented for display. These PTS are different from the RTP timestamps of the original media stream 110, even though the actual encoding between incoming and outgoing media stream media remains unchanged.

The mixer 104 may mix one or more elementary streams in media stream 111 with the original media stream 110. Thereafter, it may send the mixed media stream 114 over the network to UE4 109. As the mixer generates a new media stream it will use a new randomly generated RTP timestamp as the starting time for transmitting this stream to UE4 whereby both the encoding and transport schemes used for the input stream 110 and the mixed output stream 114 are the same.

Without any further measures, synchronization of the play-out at the UEs is not possible because the content modification units in the network change the timing information in the streams so that the timestamps at the source and UEs do not correlate with each other. The reason being that the media server 101, the transcoders 102 and 103 and the mixer 104 each choose a random timestamp as a starting time. This same problem exists for the mixer: it receives media streams from both the original media server 101 and from another source, i.e. the media server containing additional and alternative elementary streams 105. As explained above, the timestamps in these media streams will not be correlated.

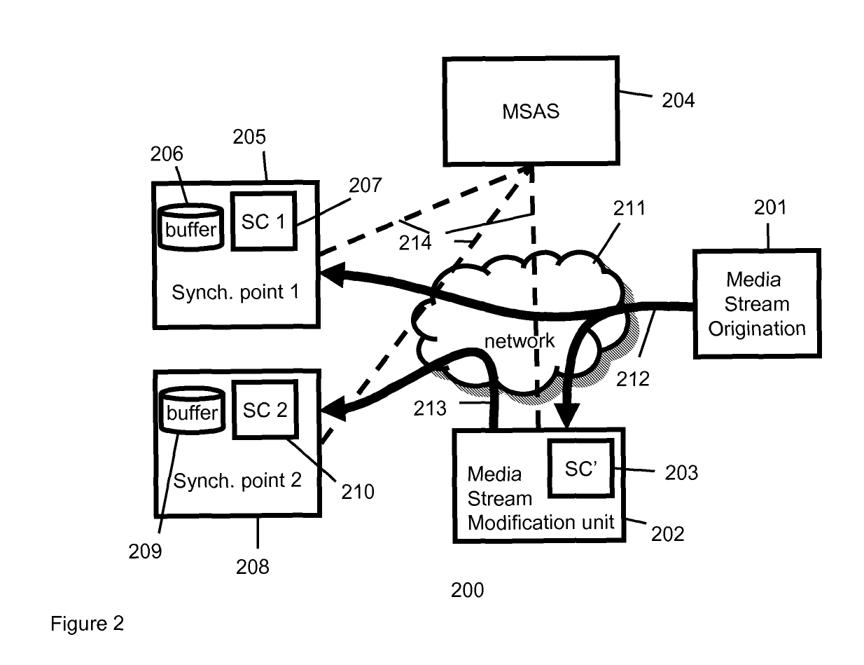

FIG. 2 illustrates a schematic of a multi-media delivery system 200 comprising a first synchronization point 205 and a second synchronization point 208 for synchronizing a media stream. A synchronization point is a (logical or physical) point in the path of stream for which the synchronization information (e.g. the arrival time information) is determined. A synchronization point may be comprised in any physical device connected to or incorporated in a network. It may for instance relate to a network node, such as an access node (for example a Digital Subscriber Line Access Multiplexer (DSLAM), Cable Modem Termination System (CMTS)), an optical access node or an edge router or a head-end. Alternatively, a synchronization point may be configured as a set-top box connected to a television, a personal computer, laptop, net-book, personal digital assistant or any other device capable of handling the media stream.

The multi-media delivery system may contain a media stream origination 201, e.g. a media server, delivering e.g. a video-on-demand stream or a live multicast television broadcast. This media origination 201 may transmit an original first media stream 212 over the network 211 to the synchronization points. The first synchronization point 205 may receive the original media stream 212 without any modifications. The second synchronization point 208 however may receive a stream comprising the same content but e.g. in a different format. Hence, the second synchronization point 208 receives a modified second media stream 213 generated by a media stream modification unit 202, which receives the original media stream 212 and generates modified media stream 213.

The first and second stream synchronization points 205,208 may be configured to provide inter-destination synchronization (or group synchronization) between the first and second media streams 212, 213 respectively. To that end, the media stream synchronization points are connected to a media synchronization unit 204, e.g. a media synchronization application server (MSAS). The first and second stream synchronization points 205,208 may comprise first and second synchronization clients 207,210 and first and second variable delay unit each comprising e.g. a variable delay buffer 206, 209 respectively. The first and second synchronization clients 207,210 are configured for exchanging synchronization information with the MSAS 204 as explained in more detail below.

The media stream modification unit 202 may further comprise a third synchronization client SC′ 203 associated with the media stream modification unit. The synchronization clients 207,210,203 exchange messages with the MSAS 204 using e.g. signaling paths 214. These signaling messages may be transported over the same network 211 used in media distribution. Alternatively, the messages may be transported over other networks as well. For the explanation below signaling paths 214 are referred to as synchronization reference points.

In this example, the original media stream 212 may for example relate to a video stream carried in RTP over an IP network using the UDP protocol. In that case, the RTP packets in the original media stream 212 may contain an RTP timestamp generated by the media stream origination 201 and a synchronization source (SSRC) identifier as defined in the RTP protocol.

The modified stream 213 may contain the same content as the original media stream 212 but is modified by the media stream modification unit 202. The modification may be a modification operation as described above with reference to FIG. 1., e.g. the original stream may be a high-bandwidth High Definition (HD) stream and the modified stream may be a low-bandwidth Standard Definition (SD) stream. Another modification may e.g. be the application of an encryption scheme associated with a Digital Rights Management (DRM) system supported by one or more stream synchronization points in the network. The modification may also relate to re-origination. Re-origination may be provided when media streams cross network boundaries, e.g. when an IPTV provider wants to offer media streams available on the Internet also to one or more of its private IPTV networks. Other modifications may include modifications based on mixing, e.g. including a person performing sign language in the video stream, or resending the streams in a different media container, e.g. using an MPEG Transport Stream (TS) instead of using RTP.

The RTP packets in the modified media stream 213 may contain a different SSRC identifier and different RTP timestamps compared to those in the original media stream 212. According the IETF RFC 3550, the SSRC identifier and the RTP timestamp are 32 bit header fields in a RTP packet. For each media stream the starting time of an RTP time stamp should be chosen randomly. Further, the SSRC is a randomly chosen value, which is meant to be globally unique. In known inter-destination synchronization schemes, synchronization may be achieved by signaling timestamp information to each stream synchronization point. However, as the RTP timestamps in the first and second streams 212, 213 are different, direct synchronization of the media streams at first and second synchronization points is not possible.

In the multi-media delivery system the first and second stream synchronization points 205, 208 may send so-called synchronization status information to the MSAS 204. This synchronization status information may contain the identification information associated with the media stream (e.g. an SSRC identifier), and the timing information (e.g. an RTP timestamp and an NTP timestamp associated with the play-out time of a packet).

The RTP timestamp reflects the sampling instant of the first octet in the RTP data packet. The initial value of the timestamp is a random value. The RTP timestamp counts sampling periods so if a second RTP packet starts 160 samples after a first RTP packet, then the second RTP time stamp is 160 higher than the first.

The NTP timestamp is an absolute “wall clock” time. NTP is a 64-bit counter of which started 1 Jan. 1900 as defined in IETF RFC 1305. The 64-bit timestamps used by NTP consist of a 32-bit seconds part and a 32-bit fractional second part. It represents the absolute time that the first octet, identified by the RTP timestamp, passes a specific point, i.e. a synchronization point.

This specific point may be the play-out point of the User Equipment (UE) that contains the SC wherein the NTP timestamp represents the time that the specified octet is played to the user. Alternatively, it may be the ingress point, at which a SC first receives a specified octet. In a similar way, for a synchronization SC′ this specific point may be an output point or an input point.

The first stream synchronization point may send the following first synchronization status information message to the MSAS:
SSRC identifier=12345678
RTP timestamp=1556688423
NTP timestamp=13:42:21.000
   Similarly, the second media stream synchronization point may send the following second synchronization status information message to the MSAS:
SSRC identifier=90ABCDEF
RTP timestamp=1684654845
NTP timestamp=13:42:21.000

In this example, the information from the first and second stream synchronization points is associated with the same NTP play-out time: 13:42:21.000. In this example, it is assumed that both media stream synchronization points are NTP synchronized, i.e. their clocks are synchronized using the Network Time Protocol or some other means.

As explained above, although the modified media stream carries the same content, synchronization may not be possible due the media stream modification unit 202 modifying the timing information in the modified output stream 213. In order to enable synchronization, the synchronization client SC′ associated with the media stream modification unit 202 may send a synchronization correlation information message on the synchronicity relationship between an incoming media stream 212, received by the media stream modification unit, and outgoing media stream 213, transmitted by the media stream modification unit to the second media stream synchronization point. Hence, the synchronicity relationship relates to first timing information in a first packet and second timing information in a second packet, wherein the first and second packet comprise the same content or a part thereof and wherein said second packet is part of a stream modified by the media stream modification unit and wherein said first packet is part of a media stream prior to said modification.

In one embodiment, the media stream modification unit may send the following information to the MSAS:
incoming:
SSRC identifier=12345678
RTP timestamp=1556688423
outgoing:
SSRC identifier=90ABCDEF
RTP timestamp=1684657845
   This information contains both an incoming SSRC identifier/RTP timestamp pair and an outgoing SSRC identifier/RTP timestamp pair. Hence, the synchronization correlation information message may allow correlation of one or more streams received at the input of the stream modification unit with one or more streams transmitted at the output of a stream modification unit using the SSRC and/or the RTP timestamps signaled to the MSAS.

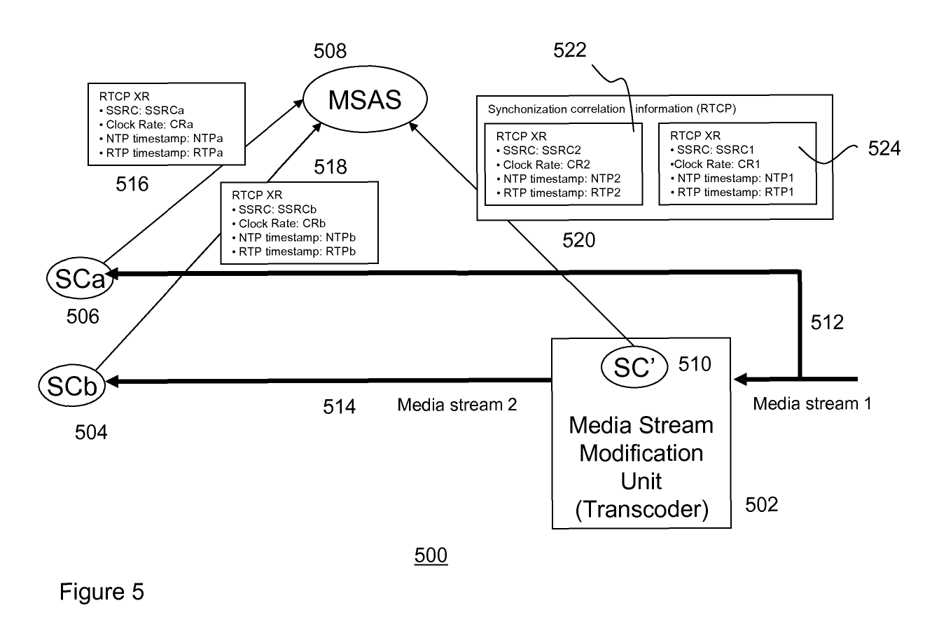

In one embodiment the synchronization correlation information may be sent in one message to the MSAS. In another embodiment it may be sent in two separate messages. The use of separate messages may be advantageous if the synchronization parameters of either the ingoing or the outgoing stream(s) do no vary much over time so that signaling of synchronization information associated with these streams is required less frequently. Further details about the signaling of the synchronization information is described hereunder with reference to FIG. 5-7.

The MSAS 204 receives the first and second synchronization status information messages from both media stream synchronization points and the synchronization correlation information message containing the synchronicity relationship from the media stream modification unit. Thereafter, it uses this information to calculate timing information for the first and second media stream synchronization points.

This calculation may involve two calculation steps. The first step relates to a calculation to adjust all synchronization status information to a single timeline (time base). In the second step, the actual delay information is calculated. In the example below, it is assumed that both RTP timestamps represent a millisecond scale. If this is not the case, calculations should be adjusted to reflect this. So in a first step, all synchronization status information is adjusted to one common timeline, e.g. to the timeline associated with the RTP timestamps of the original media stream 212. This step is referred to as the status information conversion step.

At 13:42:21.000, the first media stream synchronization point 205 is at timestamp 1556688423. In this example, that the timestamp provided by the second media stream synchronization point 208 will be adjusted to the timeline associated with the original media stream 212. In other variants, it may also be possible to adjust the synchronization status information on the basis of a timeline associated with the modified stream or to adjust the timelines of both streams to a new (third) timeline. An example of a third timeline may relate to a situation wherein each media stream starts at timestamp 0 so that the first randomly chosen timestamp of each stream require adjustment to 0.

To adjust the synchronization status information received from the second media synchronization point 208, the following information is used:
RTP timestamp in the synchronization status information of the modified stream having a value 1684654845; and,
RTP timestamp value 1684657845 associated with the modified stream correlates with RTP timestamp value 1556688423 associated with the original stream.
   The calculation for adjusting the timestamp may relate to a simple linear transformation: adjusted timestamp=conv_timestamp_org_stream+conv_timestamp_mod_stream−timestamp_mod_stream_current. Hence, at 13:42:21.000 the second media stream synchronization point 208 may be associated with adjusted timestamp 1556688423+1684654845−1684657845=1556685423. That way, the synchronization status information received from the second media stream synchronization point 208 may be adjusted to the timeline associated with the synchronization status information received from the first media stream synchronization point 205.

Thereafter the calculation of the delay information may be performed according to known schemes. For example, the delay information may be determined on the basis of the client which is most behind in playing the media stream. Since both timestamps in the example described above are reported at the same clock-time 13:42:21.000, the calculation may involve a simple subtraction of the synchronization status information of both media stream synchronization points: 1556685423−1556688423=−3000. This result indicates that the media stream at the second media stream synchronization point 208 is 3 seconds behind on the media stream at the first media stream synchronization point 205. This time-lag may be attributed to a transcoding process executed in the media stream modification unit 202. If the reported clock-time (i.e. the NTP time) differs in the different synchronization status information messages received by the MSAS, this clock-time difference should be taken into account in the calculation for determining the delay.

From the above it follows that the modified stream is 3 seconds behind (as shown by the 4th digit from the right in the timestamp). In another embodiment, the timeline of the adjusted media stream may be used: 1684657845 ms−1684654845 ms=3000 ms. Hence, to synchronize the media streams at both media stream synchronization points, the MSAS may send synchronization setting instructions to the first synchronization point 205 to delay play-out by 3 seconds.

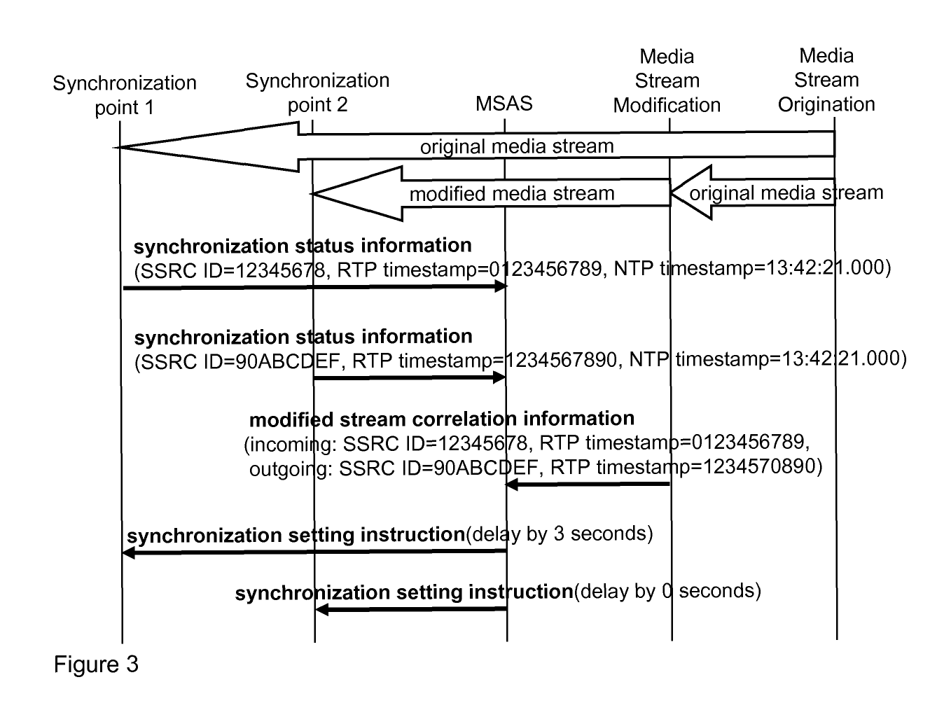

FIG. 3 depicts the exchange of information in a message flow diagram 300 for the example as described above with reference to FIG. 2. In a first step 302, the first synchronization point receives the original media stream from the media stream origination and the second synchronization point receives a modified media stream from the output of the media stream modification unit, wherein the media stream modification unit uses the original media stream from the media stream origination as its input signal.

In a second and third step 304,306, the first and second synchronization points each send a first and second synchronization status information message respectively to the media synchronization application server (MSAS). Thereafter, in a fourth step 308, the media stream modification unit sends a correlation information message on the synchronicity relationship between the incoming media stream and outgoing media stream to the MSAS. The MSAS may subsequently calculate in a fifth step 310 synchronization setting instructions and send these instructions to the destinations, i.e. first and second synchronization points.

The non-limiting example described with reference to FIG. 2 and FIG. 3 illustrates an inter-destination synchronization scheme using one media stream modification unit and two synchronization points. In further variants, such scheme may be used with two or more stream modification units and/or with two or more media synchronization points. Different protocols may be used for transporting the signaling messages (e.g. the synchronization status information messages, the messages containing the information correlating the different timestamps, the synchronization settings instructions) over the network. These messages may for example be carried in XML format using SOAP over HTTP (W3C recommendation), in XML format or in plain text in a MIME message body in a SIP message (IETF RFC 3261) or in RTCP messages.

In the example described with reference to FIGS. 2 and 3, the variable delay unit and the synchronization unit are implemented in a client-server type model wherein the functionality of the variable delay unit in a synchronization point may be implemented as part of a synchronization client (SC) and wherein the synchronization unit may be implemented as a synchronization server (SYNCHS or Media Synchronization Application Server (MSAS)). The synchronization client may have a protocol socket enabling synchronization status information to be sent using a suitable protocol to the synchronization server (synchronization unit) and synchronization settings instructions to be received from the synchronization server.

Synchronization status information may include timing information on stream reception (i.e. the arrival time of a packet in a stream arriving at a first synchronization point) and may include the current delay settings. Hence, the synchronization status information may comprise information regarding a point in time at which a packet in the stream was received by the synchronization point. Synchronization settings instructions may include instructions on setting the variable delay buffer using for example the actual calculated delay.

The terms synchronization settings instructions and delay instructions are terms used in an equivalent manner for the purpose of this invention and may comprise the actual delay time of a certain media stream. Preferably, these delay instructions may contain a positive time value associated with delaying a media stream for a predetermined duration. Alternatively, the delay instructions may contain a negative time value associated with speeding up the play-out or output of a media stream. This may be the case, when a certain synchronization point contains a large buffer and allows shortening of the delay by decreasing the buffering time using known measures.

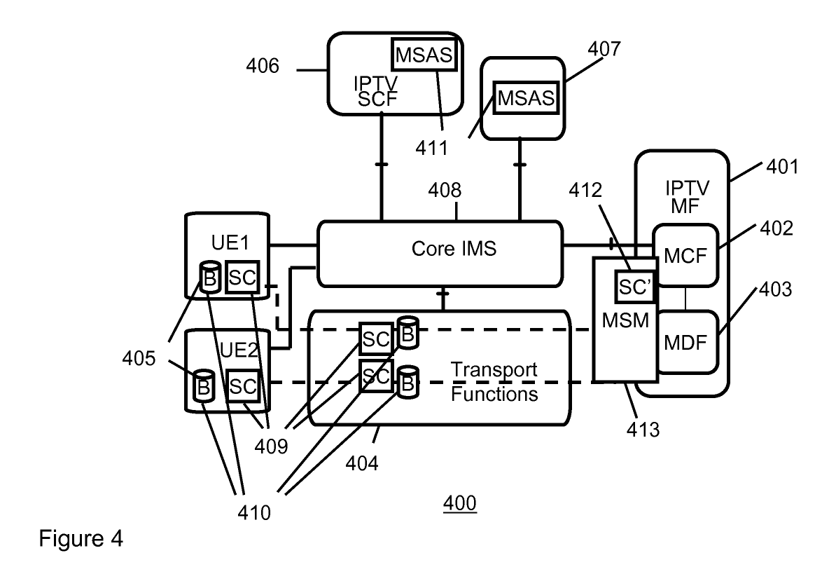

FIG. 4 depicts an exemplary content delivery system according to the invention implemented as an IMS-based IPTV system 400 as specified in ETSI TS 182 027 version 2.0.0. The IPTV system 400 comprises an IPTV Media Function (MF) 401, containing a Media Control Function (MCF) 402 and a Media Delivery Function (MDF) 403. Further, it comprises Transport Functions (TF) 404, User Equipments (UE) 405, an IPTV Service Control Function (SCF) 406, a separate application server (AS) 407 and a core IMS network (Core) 408. A Synchronization Client (SC) 409 may be part of an UE 405 or be part of the Transport Functions 404. If a User Equipment is capable of buffering a stream as part of the synchronization method, the may be implemented in the User Equipment. SCs may also be implemented in the transport network for example when the User Equipment does not support a buffering function.

The SC is associated with at least one variable delay buffer, hence when an SC is implemented in a UE, it may also comprise one or more associated variable delay buffers 410. Similarly, if the SC is implemented as part of the Transport Function, the element comprising the Transport Function may also comprise one or more variable delay buffers 410. The functionality of the MSAS 411 may be included in a standard IPTV Service Control Function 406, as part of the Transport function or the Media Function or, alternatively, it may be implemented on a stand-alone application server 407. A Media Stream Modification Unit (MSMU) 413 may be part of the IPTV Media Function 401. The MDF 403 may perform the actual transcoding, while the MCF 402 may contain the synchronization client (SC′) 412.

FIG. 5 depicts an implementation of the inter-destination synchronization scheme 500 according to one embodiment of the invention wherein RTCP RTP Control Protocol (RTCP) is used to convey synchronization information between elements in a media distribution system. The system comprises two synchronization clients SCa,SCb 502,504. The synchronization clients are set up to signal synchronization status information associated with a first and second media stream 512,514 to an MSAS 508. The two synchronization clients reside in two User Equipments (UEs) (not shown) that receive the two different RTP media streams, which may have different sampling rates. A first media stream 512 received by SCa, may be an original media stream associated with a media stream origination (i.e. a media server) and a second media stream 514 received by SCb, may be a modified media stream. A media stream modification unit (transcoder) 502, which modifies the first media stream in to the second media stream, comprises a special Synchronisation Client SC′ 510 that reports the synchronization relationship between the first and second media stream to the MSAS.

The system may use SIP to set-up media sessions between the UEs, the media stream modification unit and a media stream origination. The Session Description Protocol (SDP) carried by SIP signaling may be used to describe and negotiate the media components in each session. During set-up the UEs (and the media stream modification unit) may be associated with a SyncGroupId, which identifies the synchronization group the specific UE belongs to.

A synchronization group is a group of UE's that require to be synchronized with respect to one or more designated media streams. An example of such a group may be two UE's belonging to two different users on two different locations requesting to watch the same Content on Demand (movie) together in a synchronized manner.

For a detailed description of setting up a synchronization session reference is made to co-pending European patent application ______ with title Dynamic RTCP rely, which is hereby incorporated by reference into this application.

Further, the UEs and the media stream modification unit, in particular the synchronization clients located therein, may use the RTP Control Protocol (RTCP) to transmit synchronization information to the IP address and port number associated with the MSAS and to receive RTCP reports from the MSAS on a an RTCP receiver port associated with an UE. In one embodiment, the synchronization client may include synchronization status information in its RTCP Receiver Reports (RTCP RR) using RTCP eXtended Reports (RTCP XR) and send this information in one or more RTCP messages to the MSAS.

In particular, a synchronization client may generate a specially formatted RTCP eXtended Report (RTCP XR) 516,518 comprising synchronization status information. This information may be in the form of RTP timestamps combined with NTP timestamps. The RTCP XR may further comprise the SSRC of source, the Packet Received NTP timestamp, the Packet Received RTP timestamp (RTP receipt time stamp) and, optionally, a SyncGroupId parameter. Further, it may comprise the Packet Presented NTP timestamp (NTP presentation time stamp) into the XR.

The SyncGroupId parameter may be implemented as a Session Description Protocol (SDP) session level attribute, e.g. a=RTCP-xr:sync-group=<value> or for example in the form of SDES PRIV items according to IETF RFC 3550. In a further embodiment, the RTCP-xr attribute field known from IETF RFC 3611 may be used.

The synchronization client associated with the media stream modification unit SC′ reports synchronization correlation information to the MSAS. In contrast to the synchronization clients associated with the UEs, SC′ transmits RTCP XRs associated with one or more media steams at the input of the transcoder and RTCP XRs associated with one or more media streams at the output of the transcoder. Generally, synchronization correlation information 520 is formed by two RTCP XRs, a first RTCP XR 522 associated with an input stream and a second RTCP XR 524 associated with an output steam (i.e. the modified input stream). Hence, the synchronization correlation information may comprise two sets of timestamps (RTP1,NTP1) and (RTP2,NTP2), one associated with an input stream and one associated with an output stream.

The MSAS may further send RTCP XRs comprising synchronization settings instructions to the synchronization clients SCa,SCb. These RTCP XRs may include the SSRC of source, the reference Packet Received NTP timestamp and the reference Packet Received RTP timestamp receipt time stamp. It may further comprise a reference Packet Presented NTP timestamp. These RTCP XRs may be both appended to RTCP Sender Reports (SRs) or may be received separately by an UE.

The synchronization settings may be in the form of RTP timestamps combined with NTP timestamps wherein the NTP timestamp indicates the clock shared by the synchronization group as e.g. identified by SyncGroupId and the RTP time stamp indicates the expected presentation time.

In one embodiment, a synchronization client may be co-located with the MSAS. In that case, the exchange of synchronization status information and synchronization settings instructions is internal to one or more functional entities of the MSAS in which they reside.

In another embodiment, the synchronization may relate the synchronization of one or more broadcast streams. In that case, the MSAS may function as a Feedback Target as described in more detail in RFC 3550. Before forwarding RTCP Receiver Reports, the MSAS may read and remove RTCP eXtended Reports containing synchronization status information. The MSAS may subsequently send synchronization settings instructions to the synchronization client using RTCP eXtended Reports.

In case of synchronization of Content on Demand or other unicast streams, the MSAS may forward RTCP Receiver Reports associated with one or more UEs to the appropriate media function MF. Before forwarding RTCP Receiver Reports, the MSAS may read and analyse the RTCP XR and remove those RTCP eXtended Reports containing synchronization status information. The MSAS may subsequently forward RTCP Sender Reports to the appropriate synchronization clients, appending synchronization settings instructions to the SC using RTCP eXtended Report. The MSAS may send synchronization settings instructions to the synchronization clients using a separate RTCP XR.

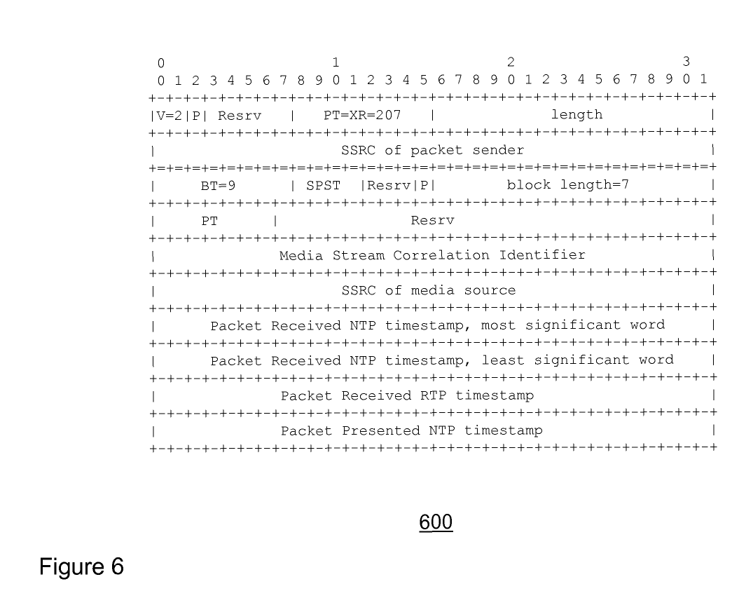

FIG. 6 depicts an exemplary RTCP eXtended Report for reporting synchronization information on an RTP media stream according to one embodiment of the invention. The following fields in the synchronization RTCP XR may be used in the synchronization scheme according to the invention:
An SSRC of packet sender identifying the sender of the specific RTCP packet.
A Block Type (BT) field comprising 8 bits for identifying the block format.
A Synchronisation Packet Sender Type (SPST) field comprising 4 bits for identifying the role of the packet sender for this specific eXtended Report.
A Packet Presented NTP timestamp flag (P) which may be set to 1 if the Packet Presented NTP timestamp contains a value. If this flag is set to zero, then the Packet Presented NTP timestamp shall not be inspected.
A Payload Type (PT) field comprising 7 bits for identifying the format of the media payload. The media payload may be associated with an RTP timestamp clock rate, which provides the time base for the RTP timestamp counter.
A Media Stream Correlation Identifier (32 bits) for use in correlating synchronized media streams. If the RTCP Packet Sender is an SC or an MSAS (SPST=1 or SPST=2), then the Media Stream Correlation Identifier maps on the SyncGroupId. If the RTCP Packet Sender is an SC′ (SPST=3 or SPST=4), related incoming and outgoing media streams may have the same Media Stream Correlation Identifier.
An SSRC of media source (32 bits) may be set to the value of the SSRC identifier carried in the RTP header of the RTP packet to which the XR relates.
A Packet Received NTP timestamp (64 bits) may represent the arrival time of the first octet of the RTP packet to which the XR relates.
A Packet Received RTP timestamp (32 bits) is associated with the value of the RTP time stamp carried in the RTP header of the RTP packet to which the XR relates.
A Packet Presented NTP timestamp (32 bits) reflects the NTP time when the data contained in the first octet of the associated RTP packet may be presented to the user. It comprises the least significant 16 bits of the NTP seconds part and the most significant 16 bits of the NTP fractional second part. If this field is empty, then it may be set to 0 and the Packet Presented NTP timestamp flag (P) may be set to 0.

Table 1 illustrates values associated with The Synchronisation Packet Sender Type (SPST) field:

TABLE 1

| | Role of | |
|---|---|---|
| SPST | packet | |
| value | sender | Details |
| 0 | Reserved | For future use. |
| 1 | SC | The packet sender uses this XR to report |
| | | synchronisation status information. |
| | | Timestamps relate to the SC input. |
| 2 | MSAS | The packet sender uses this XR to report |
| | | synchronisation settings instructions. |
| | | Timestamps relate to the input of a |
| | | virtual SC, which acts as reference to |
| | | which the SCs connected to this MSAS are |
| | | synchronized. |
| 3 | SC′ input | The packet sender uses this XR to report |
| | | synchronisation correlation information |
| | | related to the incoming media stream of |
| | | SC′. Timestamps relate to the SC′ input. |
| 4 | SC′ output | The packet sender uses this XR to report |
| | | synchronisation correlation information |
| | | related to the outgoing media stream of |
| | | SC′. Timestamps relate to the SC′ input. |
| 5-15 | Reserved | For future use. |

Using the specially formatted RTCP eXtended Reports as described with reference to FIG. 6, synchronization information may be efficiently signaled between clients in the network or one or more UEs and the MSAS. For example in the system depicted in FIG. 5, the synchronization clients SCa, SCb 504,506 associated with the UEs and the synchronization client SC′ 510 associated with the media stream modification unit may use the RTCP XR to report synchronization information (i.e. synchronization status information or synchronization correlation information) to the MSAS. Table 2 provides an example of this information:

TABLE 2

| | | | | SC′ reports on the | |
|---|---|---|---|---|---|
| | | | | first incoming | |
| SCa reports on the | | SCb reports on | | media stream and | |
| first incoming | | second incoming | | the second outgoing | |
| media stream | | media stream | | media stream | |
| SSRC: | SSRCa | SSRC: | SSRCb | SSRC: | SSRC1 |
| Clock rate: | CRa | Clock rate: | CRb | Clock rate: | CR1 |
| NTP timestamp: | NTPa | NTP timestamp: | NTPb | NTP timestamp: | NTP1 |
| RTP timestamp: | RTPa | RTP timestamp: | RTPb | RTP timestamp: | RTP1 |
| | | | | SSRC: | SSRC2 |
| | | | | Clock rate: | CR2 |
| | | | | NTP timestamp: | NTP2 |
| | | | | RTP timestamp: | RTP2 |

The media streams may be identified by their Synchronization Source (SSRC identifier): SSRCa=SSRC1 and SSRCb=SSRC2. This way, the MSAS may derive that SCa receives the first media stream and that SCb receives the second media stream. Further, each media stream may be associated with a specific clock rate, which may be expressed in Hz (i.e. clock ticks per second): CRa=CR1 and CRb=CR2. Typical clock rates are within the range between 8000 and 96000 samples per second for audio, and 90.000 samples per second for video.

In one embodiment the clock rate may be signaled to the MSAS. In other embodiments the rates are constant. In yet another embodiment, the Payload type instead of the clock rate may be signaled to the MSAS. The Payload Type may be mapped to a clock rate using e.g. schemes described in IETF RFC 3551. The information reported to the MSAS may further include both an RTP timestamps and NTP timestamps.

The SC′ reports two sets of timestamps (RTP1,NTP1) and (RTP2,NTP2), one for each media stream, to the MSAS. NTP1 represents the time that the octet identified by RTP1 has passed the specific point in the SC′ and NTP2 represents the time that the octet identified by RTP2 has passed the specific point in the SC′. These are typically different octets due to the transcoding and clock rate change. The SC′ has to make a calculations to determine NTP1 and NTP2, in order to determine when the point in the content, represented by the identified octet, passes the specific point.

The MSAS may use the algorithm: Playout SCa−Playout SCb=(NTPa−(RTPa/CRa)−(NTPb−(RTPb/CRb)−(NTP1−(RTP1/CR1)+(NTP2−(RTP2/CR2) to determine the difference between the play-out of SCa and SCb in miliseconds. The result may be used to instruct SCa or SCb to delay its play-out by the specified amount, in order to have their playouts sufficiently synchronized.

Using the parameters from example in table 3, results in a delay (Playout SCa−Playout SCb) of −5.493 seconds, indicating that SCb plays out 5.493 seconds later than SCa. Hence, on the basis of this calculation the MSAS may instruct SCa to delay its output by 5.493 seconds in order to become substantially synchronized.

TABLE 3

| Parameter | Value | Unit |
|---|---|---|
| CRa = CR1 | 96000 | Hz |
| CRb = CR2 | 8000 | Hz |
| NTPa | 3439700021.000 | Sec |
| RTPa | 1556688423 | Samples |
| NTPb | 3439700020.300 | Sec |
| RTPb | 3574215512 | Samples |
| NTP1 | 3439700022.500 | Sec |
| RTP1 | 1556333112 | Samples |
| NTP2 | 3439700021.000 | Sec |
| RTP2 | 3574223444 | Samples |

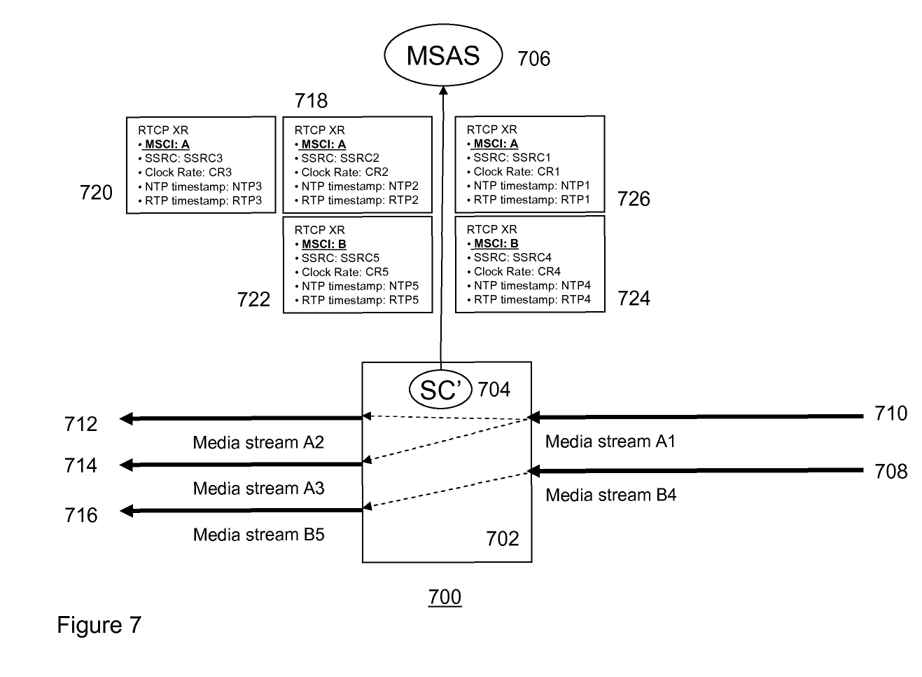

FIG. 7 depicts the use of RTCP XR messages for synchronizing media stream according another embodiment of the invention. In this example, one single encoding device 702 may contain multiple media stream modification units. The encoding device may be associated with multiple incoming media streams 708,710 and outgoing media streams 712-716, which may be synchronized by a single synchronization client SC′ 704.

For each incoming media stream A1, B4, . . . and for each outgoing media stream A2, A3, B5, . . . the synchronization client SC′ may send an RTCP XRs 718-724 to the MSAS 706. Hence, in this embodiment, the synchronization correlation information is sent in two RTCP XRs to the MSAS: a first RTCP XR 724,726 associated with the incoming media stream 708,710 and a second RTCP XR 718-722 associated with the outgoing media stream 712-716.

Such signaling scheme has the advantage that the RTCP XRs may be sent independently at different times and at different rates to the MSAS. If one media steam has a more constant time reference, then its synchronization correlation information may be updated less regularly, hence saving processing time and bandwidth. Moreover, if one incoming media stream is transcoded into multiple different outgoing media streams, then the part of the synchronization correlation information related to the incoming media stream should be measured and sent only once thereby saving processing time and bandwidth.

However, sending the different parts (RTCP XRs) of the synchronization correlation information independently may pose a problem as the MSAS does not know which parts of the synchronization correlation information are related. In that case, it is not possible for the MSAS to determine which parts of the synchronization correlation information belong together.

For that reason, the synchronization client SC′ generates a Media Stream Correlation Identifier (MSCI) in order to enable the MSAS to correlate the different media streams at the input and output of the transcoding device and to derive the correct synchronization correlation information from the different RTCP XRs received by the MSAS. For example, in FIG. 7 the MSAS may use MSCIA to correlate RTCP XR 726 associated with media stream 710 with first RTCP XR 718 associated with (modified) media stream 712 and second RTCP XR 720 associated with (modified) media stream 714. This way efficient synchronization of multiple modified media streams may be achieved. It is noted that synchronization between different related streams may not only be advantageous for different users using different play-out devices with different capabilities and wanting to experience the same broadcast at the same moment, it may also be beneficial for a single user switching between two or more networks transporting different related streams. This switching may occur for example when a user uses a mobile network with bad coverage. If a user looses his connection to that network he may want to switch to another network, e.g. another mobile network with improved coverage. An example of such network switching may be the switching between a DVB-H (Digital Video Broadcast-Handheld) network and an UMTS-network. The switching may also occur between a mobile network and a fixed network, for example when a user watching a video stream via a mobile network, comes home and wants to continue watching on his large-screen television connected to a fixed network. Canceling delays between different related streams may thus provide seamless network transitions and improved user experience.

Any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

For example, the synchronization method according to the invention may be implemented as a continuous process operating e.g. on a whole network or parts thereof, or operating on all streams running through the network or certain streams only. Further, the continuous operation may affect all synchronization points or only certain synchronization points. The method may be implemented by configuring the system to operate in this continuous modus.

Alternatively, the method may be implemented as a session-type synchronization process using e.g. a client-server type model. Synchronization sessions may for example be initiated or terminated through certain triggers within the network. Triggers for initiating or terminating a synchronization session may for instance be provided by synchronization points or by other elements within the network or system.

In an embodiment the synchronization server and synchronization client may be configured to initiate and terminate synchronization sessions. A synchronization session may be initiated when a synchronization client sends an invitation message to the synchronization server, or vice versa. During a synchronization session, the synchronization server and the synchronization client may exchange synchronization status information and synchronization settings instructions. A synchronization session may be terminated when the synchronization client sends a termination message to the synchronization server, or vice versa. A synchronization server and a synchronization client may send return messages to accept the invitation to, or to confirm the termination of a synchronization session.

1. Method for inter-destination synchronization of at least a first and at least a second stream, said second stream being associated with an output stream of a media stream modification unit using said first stream as an input stream, the method comprising:
providing first arrival time information of a packet in the first stream arriving at a first synchronization point and second arrival time information of a packet in the second stream arriving at a second synchronization point;
providing synchronization correlation information on a synchronicity relationship between said input stream and said output stream; and
calculating delay information based at least on the first and second arrival time information and the synchronization correlation information.

2. Method according to claim 1, the method further comprising:
providing at least said first or second synchronization point with said delay information and enabling the at least said first or second synchronization point to delay the output of a stream such that the first and second streams outputted by the first and second synchronization point respectively are substantially synchronized.

3. Method according to claim 1, wherein said first and second stream are outputted by at least said first and second synchronization points, and wherein said synchronization points being connected to at least one synchronization unit for synchronizing said first and second synchronization points.

4. Method according to claim 1, wherein calculating delay information comprises an adjustment step for adjusting the first and/or second arrival time information achieve a common timeline between first arrival time information and second arrival time information, said adjustment step being based on at least part of the synchronization correlation information.

5. Method according to claim 4, wherein the adjustment step is executed by an arrival time information adjustment module, wherein said arrival time information adjustment module is part of a synchronization unit, the synchronization unit being provided with at least part of the synchronization correlation information.

6. Method according to claim 4, wherein the adjustment step is executed at the synchronization point, the synchronization point comprising an arrival time information adjustment module, wherein the arrival time information adjustment module is provided with at least part of the synchronization correlation information and the synchronization unit being provided with adjusted second arrival time information.

7. Method according to claim 4, wherein the adjustment step is executed in a network element, wherein the network element is configured to receive arrival time information, the network element further comprising an arrival time information adjustment module, wherein the arrival time information adjustment module is provided with at least part of the synchronization correlation information and the synchronization unit is provided with adjusted second arrival time information.

8. Method according to claim 1, wherein the synchronization point is selected from the group consisting of a terminal, a network node, and an access node.

9. Method according to claim 1, wherein said stream modification unit is media stream processing device for receiving and processing at least a first media stream, wherein said processing modifies the timing information in said first media stream, preferably said media stream processing device being a translator or a mixer.

10. Method according to claim 1, wherein the synchronization unit is comprised in a synchronization point or a network node, preferably a synchronization server.

11. Method according to claim 1, wherein said arrival time information, said synchronization correlation information and/or said delay information is signaled in one or more RTCP messages, preferably one or more RTCP extended reports.

12. Method according to claim 11, wherein at least one of said RTCP messages comprises at least an identifier identifying the sender of the packet, an RIP timestamp, an NIP timestamp, a clock rate value or a media stream correlation identifier.

13. A synchronization unit for synchronizing the output of at least a first synchronization point receiving a first media stream and a second synchronization point receiving a second media stream, said second stream being the output stream of a media stream modification unit using the first stream as an input stream, the synchronization unit comprising:
a first input for receiving first timing information associated with a packet in a stream, said stream being associated with a first synchronization point and second arrival time information of a packet in the second stream arriving at a second synchronization point;
a second input for receiving synchronization correlation information on a synchronicity relationship between said input stream and said output stream; and
a processor for calculating delay information based at least on the first and second arrival time information and the synchronization correlation information.

14. A synchronization unit according to claim 13, the synchronization unit further comprising:
an output for sending the first and the second synchronization point with the delay information enabling one or more variable delay units in the first and second synchronization points to delay an output time of the received streams such that they are substantially synchronized.

15. A synchronization unit according to claim 13, wherein said arrival time information, said synchronization correlation information and/or said delay information is signaled in one or more RTCP messages, preferably one or more RTCP extended reports.

16. System for inter-destination synchronization of the output of at least a first and a second synchronization point, the system comprising:
a content delivery server for delivering a media stream;
a stream modification unit configured to modify an input media stream into a modified output media stream and configured for providing synchronization correlation information on the synchronicity relationship between said input stream and said output stream; and
at least one synchronization unit according to claim 11.

17. A synchronization point for use in a system according to claim 16, the synchronization comprising:
a first input for receiving synchronization correlation information from a stream modification unit;
an output for transmitting the arrival time information of a packet in the stream to a synchronization unit;
at least one variable delay unit; and
a second input for receiving delay information for the at least one variable delay unit enabling the synchronization point to delay the output of the stream.

18. A media stream modification unit for use in a system according to claim 16, wherein the media stream modification unit comprises means to provide synchronization correlation information associated with a synchronicity relationship between a first media stream, used by the media stream modification unit as an input stream, and a second stream being the output stream of the media stream modification unit using the first media stream as an input stream.

19. A network element for use in a system according to claim 16, wherein the network element comprises an arrival time information adjustment module, said module configured to adjust the arrival time information of a packet in a modified stream received by a synchronization point, based at least on the synchronization correlation information.

20. A data structure for use in a system according to claim 16, said data structure being used by said system for signaling synchronization status information associated with a packet in a stream arriving at a media synchronization point or a packet in a stream arriving at a media stream modification unit or a packet in a stream transmitted by said modification unit, said data structure comprising at least an identifier identifying the sender of said data structure, at least one timestamp, preferably an RIP and/or an NIP timestamp, and/or a media stream correlation identifier.

21. A computer program product comprising software code portions configured for, when run in the memory of a computer, executing the method steps as defined in claim 1.
